(19) United States
(12) Patent Application Publication
(10) Pub. No.: US 2009/0116730 A1
(43) Pub. Date: May 7, 2009

(54) THREE-DIMENSIONAL DIRECTION DETECTING DEVICE AND METHOD FOR USING THE SAME

(75) Inventors: CHIA-CHU CHENG, Yonghe City (TW); Jau-Yu Chen, Taipei City (TW); CHih-Cheng Kuan, Taipei City (TW)

Correspondence Address: RABIN & Berdo, PC, 1101 14TH STREET, NW, SUITE 500, WASHINGTON, DC, 20005, US

(73) Assignee: LITE-ON SEMICONDUCTOR CORP., Taipei Hsien (TW)

(21) Appl. No.: 12/122,791

(22) Filed: May 19, 2008

(30) Foreign Application Priority Data
Nov. 7, 2007 (TW) 96141991

(51) Int. Cl. G06K 9/00

(52) U.S. Cl. 382/154

(57) ABSTRACT

A three-dimensional direction detecting device, including: an electromagnetic radiation source and a sensing module. The electromagnetic radiation source is used to generate electromagnetic radiations. The sensing module has a plurality of sensing elements for receiving different radiation energies generated by the electromagnetic radiations from different spatial angles. Therefore, the sensing elements respectively receive the different radiation energies from different spatial direction angles generated by the electromagnetic radiation source relative to the sensing elements, so that the value of a spatial direction angle of the electromagnetic radiation source relative to the sensing module is obtained according to the magnitude relationship of the radiation energies received by the sensing module.

### BACKGROUND OF THE INVENTION

1. Field of the Invention

The present invention relates to a direction detecting device and a method for using the same, and particularly relates to a three-dimensional direction detecting device and a method for using the same by matching an electromagnetic radiation source for generating electromagnetic radiations and a sensing module having a plurality of sensing elements.

2. Description of the Related Art

FIG. 1 shows a perspective, schematic view of a three-dimensional direction detecting device of the prior art. The three-dimensional direction detecting device of the prior art uses a digital camera D to capture the image information of an object H directly, and then the image information is calculated by an image processing software in order to obtain the position of the object H in space.

However, in the prior art it is inconvenient for user to obtain the position of the object H in space by using both the digital camera D and the image processing software.

Hence, the inventors of the present invention believe that the shortcomings described above are able to be improved and finally suggest the present invention which is of a reasonable design and is an effective improvement.

### SUMMARY OF THE INVENTION

One particular aspect of the present invention is to provide a three-dimensional direction detecting device and a method for using the same. The present invention is used to detect three-dimensional direction in space by matching an electromagnetic radiation source for generating electromagnetic radiations and a sensing module having a plurality of sensing elements.

Moreover, the sensing elements of the sensing module are arranged on different planes for respectively receiving different radiation energies generated by the electromagnetic radiations from different spatial angles, so that the value of a spatial direction angle of the electromagnetic radiation source relative to the sensing module is obtained according to the magnitude relationship of the radiation energies received by the sensing module.

In order to achieve the above-mentioned aspects, the present invention provides a three-dimensional direction detecting device, including: an electromagnetic radiation source and a sensing module.

The electromagnetic radiation source is used to generate electromagnetic radiations. The sensing module has a plurality of sensing elements for receiving different radiation energies generated by the electromagnetic radiations from different spatial angles. Therefore, the sensing elements respectively receive the different radiation energies from different spatial direction angles generated by the electromagnetic radiation source relative to the sensing elements, so that the value of a spatial direction angle of the electromagnetic radiation source relative to the sensing module is obtained according to the magnitude relationship of the radiation energies received by the sensing module.

In one embodiment, the number of the sensing elements is at least five. Moreover, the normal vector of one of the sensing elements is parallel to a referring axis of a spatial coordinate, and the normal vectors of the other sensing elements each are relative to the referring axis in order to generate corresponding included angles.

Furthermore, with regard to the arrangement of the sensing elements, the present invention includes at least two arrangement manners, as follows:

1. The sensing elements are disposed on different planes in space. For example, the sensing module includes a base that has a plurality of surfaces on different planes, and the sensing elements are disposed on the surfaces with different planes; and

2. The sensing elements are disposed on the same plane in space. For example, some surfaces are arranged on the same plane by a waveguide, so that the sensing elements are disposed on the surfaces with the same plane.

In order to achieve the above-mentioned aspects, the present invention provides a method for using a three-dimensional direction detecting device, comprising:

(a) providing an electromagnetic radiation source for generating electromagnetic radiations and a sensing module having a plurality of sensing elements;

(b) using the sensing elements for receiving different radiation energies generated by the electromagnetic radiations from the electromagnetic radiation source from different spatial angles; and

(c) obtaining the value of the spatial direction angle of the electromagnetic radiation source relative to the sensing module according to the magnitude relationship of the radiation energies received by the sensing module.

Moreover, the step of (b) to (c) further includes:

building a projection transformation matrix by the sensing module relative to the electromagnetic radiation source, wherein the normal vector of the sensing element is parallel to a referring axis of a spatial coordinate, and the normal vectors of the other sensing elements each are relative to the referring axis in order to generate corresponding included angles;

selecting the radiation energies that are received by one part of the sensing elements and are larger than the radiation energies received by the other sensing elements; and

obtaining the value of the spatial direction angle of the electromagnetic radiation source relative to the sensing module according to the matrix operation of the radiation energies received by the one part of the sensing elements and the projection transformation matrix built by the sensing module relative to the electromagnetic radiation source.

Therefore, because the sensing elements of the sensing module are arranged on different planes for respectively receiving different radiation energies that are generated by the electromagnetic radiations from different spatial angles, the value of the spatial direction angle of the electromagnetic radiation source relative to the sensing module is obtained according to the magnitude relationship of the radiation energies received by the sensing module.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a perspective, schematic view of a three-dimensional direction detecting device of the prior art;

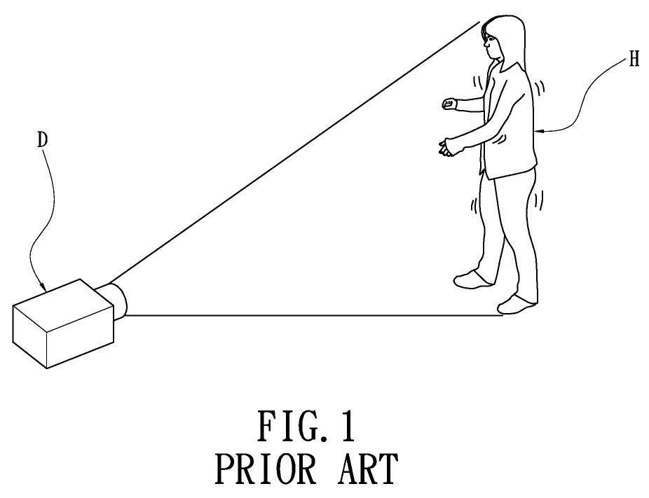

FIG. 2A is a perspective, schematic view of a sensing module of the first embodiment of the present invention;

FIG. 2B is a top, schematic view of a sensing module of the first embodiment of the present invention;

FIG. 2C is a perspective, schematic view of a three-dimensional direction detecting device of the first embodiment of the present invention;

FIG. 3 is a perspective, schematic view of a three-dimensional direction detecting device of the second embodiment of the present invention;

FIG. 4A is a perspective, schematic view of a sensing module of the third embodiment of the present invention;

FIG. 4B is a top, schematic view of a sensing module of the third embodiment of the present invention;

FIG. 4C is a perspective, schematic view of a three-dimensional direction detecting device of the third embodiment of the present invention;

FIG. 5 is a flow chart of a method for using a three-dimensional direction detecting device of the present invention; and

FIG. 6 is a three-dimensional coordinate schematic diagram of an electromagnetic radiation source relative to the sensing module.

### DETAILED DESCRIPTION OF THE PREFERRED EMBODIMENTS

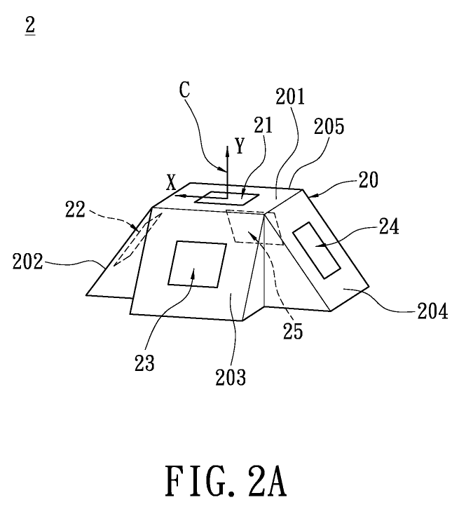

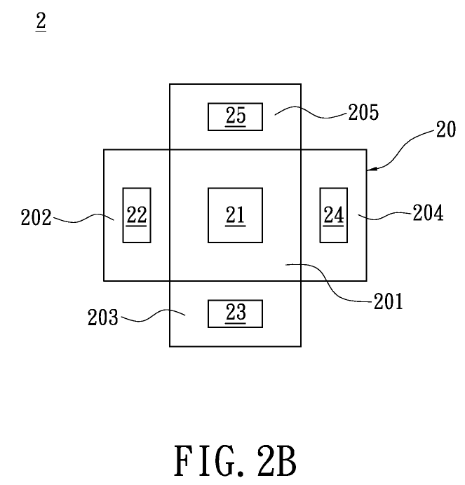

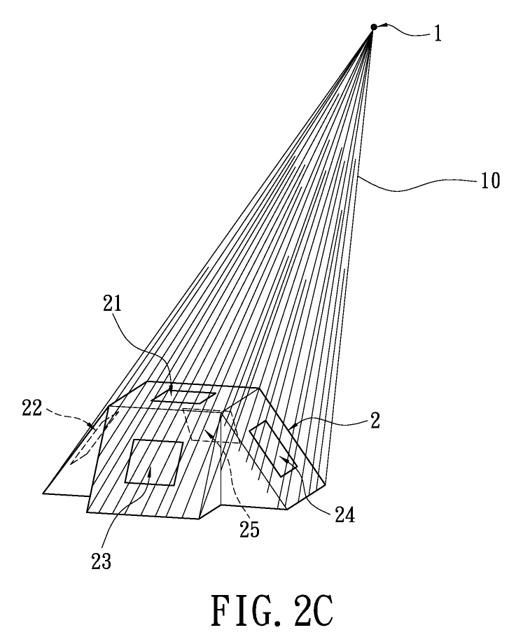

Referring to FIGS. 2A to 2C, FIG. 2A shows a perspective, schematic view of a sensing module of the first embodiment of the present invention; FIG. 2B shows a top, schematic view of a sensing module of the first embodiment of the present invention; and FIG. 2C shows a perspective, schematic view of a three-dimensional direction detecting device of the first embodiment of the present invention.

The first embodiment of the present invention provides a three-dimensional direction detecting device that includes an electromagnetic radiation source 1 and a sensing module 2.

The electromagnetic radiation source 1 is used to generate electromagnetic radiations 10. The electromagnetic radiation source 1 can be visible light or invisible light; alternatively, the electromagnetic radiation source 1 can be point source or collimated source. However, above-mentioned embodiments of the electromagnetic radiation source 1 do not used to limit the present invention. Any light source for generating electromagnetic radiations is protected in the present invention.

Referring to FIGS. 2A and 2B, the sensing module 2 has a base 20 and five sensing elements (21, 22, 23, 24, 25). The base 20 has a plurality of surfaces (201, 202, 203, 204, 205) on different planes, and the sensing elements (21, 22, 23, 24, 25) are disposed on the surfaces (201, 202, 203, 204, 205) of the base 20. Hence, from different spatial angles, the sensing elements (21, 22, 23, 24, 25) can receive different radiation energies generated by the electromagnetic radiations 10 from the electromagnetic radiation source 1.

However, the design with five sensing elements (21, 22, 23, 24, 25) is just one embodiment of the present invention. Hence, the number of the sensing elements does not limit the present invention. For example, more than three or five sensing elements can be used in the present invention. Moreover, the disclosure of the base 20 and the surfaces (201, 202, 203, 204, 205) on different planes does not limit the present invention. For example, the surfaces (201, 202, 203, 204, 205) can be arranged on the same plane, so that the sensing elements (21, 22, 23, 24, 25) can receive different radiation energies generated by the electromagnetic radiations 10 from different spatial angles by a waveguide.

Furthermore, in the first embodiment, the normal vector of the sensing element 21 (the normal vector of the sensing element 21 is a vector that is normal to the sensing element 21) of the sensing module 2 is parallel to a referring axis Y of a spatial coordinate C. The normal vectors of the other sensing elements (22, 23, 24, 25) of the sensing module 2 each are relative to the referring axis Y in order to generate corresponding included angles. However, the description of the normal vector of the sensing element 21 parallel to the referring axis Y of the spatial coordinate C does not limit the present invention. For example, according to different requirement the designer can make the normal vector of any one sensing element parallel to the referring axis Y of the spatial coordinate C, and the normal vectors of the other sensing elements each are relative to the referring axis Y in order to generate corresponding included angles.

Referring to FIG. 2C, the sensing elements (21, 22, 23, 24, 25) respectively receive the different radiation energies from different spatial direction angles generated by the electromagnetic radiation source 1 relative to the sensing elements (21, 22, 23, 24, 25). The radiation energies received by the sensing module 2 are luminous flux. Hence, the value of the spatial direction angle of the electromagnetic radiation source 1 relative to the sensing module 2 is obtained according to the magnitude relationship of the radiation energies received by the sensing module 2.

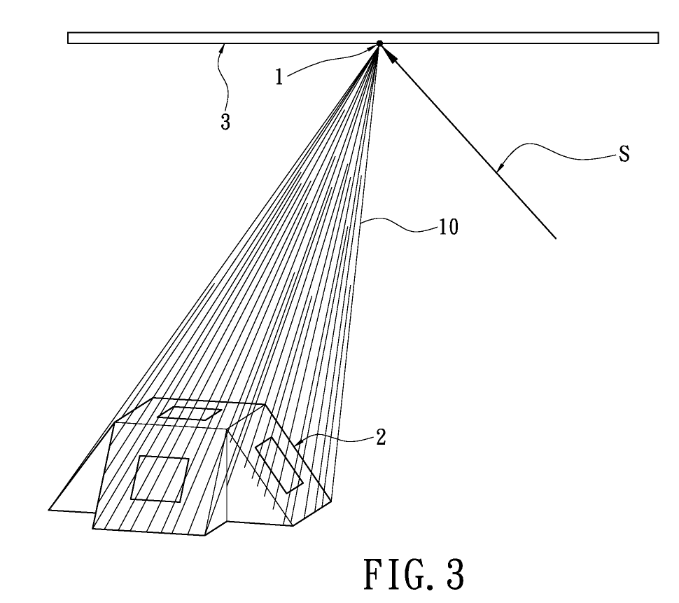

FIG. 3 shows a perspective, schematic view of a three-dimensional direction detecting device of the second embodiment of the present invention. The difference between the second embodiment and the first embodiment is that: in the second embodiment, the three-dimensional direction detecting device further includes a reflective board 3 for reflecting the electromagnetic radiations 10 from the electromagnetic radiation source 1 onto the sensing module 2. Hence, the electromagnetic radiations 10 of the electromagnetic radiation source 1 are generated by the reflective board 3. In other words, the light source S is arranged on the same side of the sensing module 2, and then the light source S is reflected by the reflective board 3 to generate the electromagnetic radiation source 1 and the electromagnetic radiations 10.

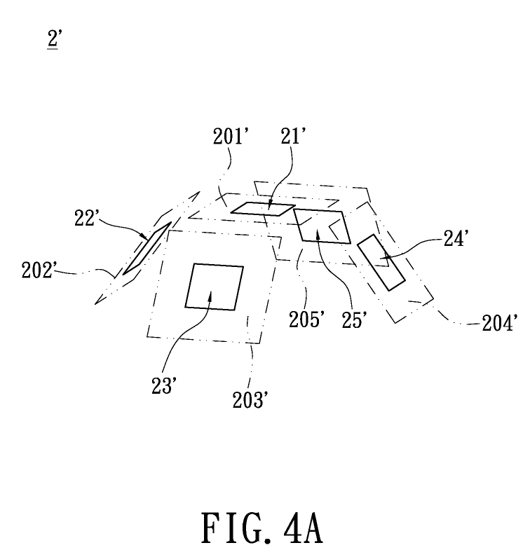

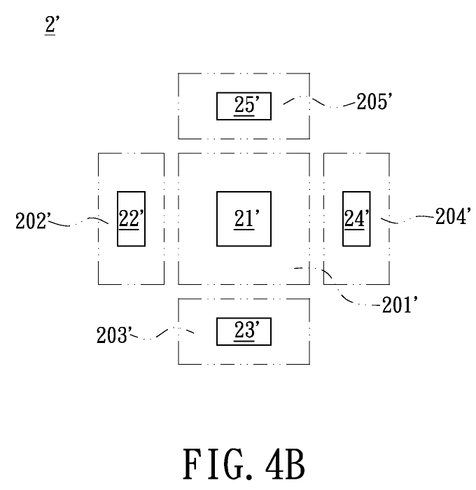

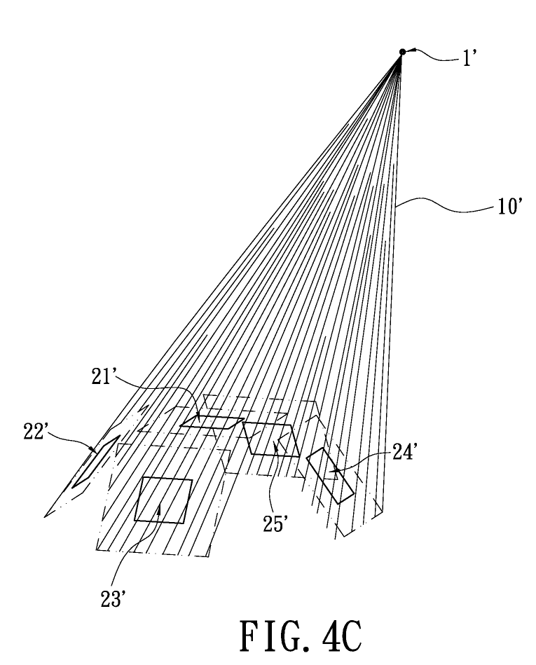

Referring to FIGS. 4A to 4C, FIG. 4A shows a perspective, schematic view of a sensing module of the third embodiment of the present invention; FIG. 4B shows a top, schematic view of a sensing module of the third embodiment of the present invention; and FIG. 4C shows a perspective, schematic view of a three-dimensional direction detecting device of the third embodiment of the present invention.

The difference between the third embodiment and the first embodiment is that: in the third embodiment, the sensing module 2′ has five sensing elements (21′, 22′, 23′, 24′, 25′) arranged on different planes (201′, 202′, 203′, 204′, 205′), and the different planes (201′, 202′, 203′, 204′, 205′) are separated from each other. In other words, according to different requirements, the sensing elements (21′, 22′, 23′, 24′, 25′) can be arranged on any different planes in spatial space, so that from different spatial angles the sensing elements (21′, 22′, 23′, 24′, 25′) can receive different radiation energies generated by the electromagnetic radiations 10 from the electromagnetic radiation source 1.

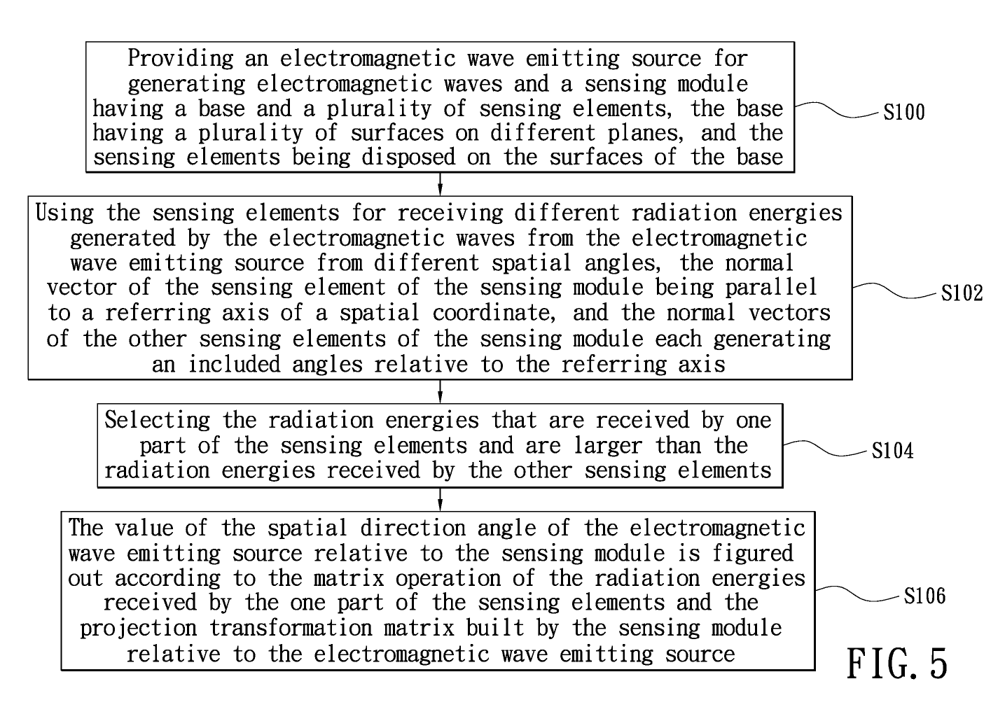

FIG. 5 shows a flow chart of a method for using a three-dimensional direction detecting device of the present invention. The first embodiment of the present invention provides a method for using a three-dimensional direction detecting device. The method includes following steps:

Step 5100 is: providing an electromagnetic radiation source 1 for generating electromagnetic radiations 10 and a sensing module 2 having a base 20 and a plurality of sensing elements (21, 22, 23, 24, 25), the base 20 having a plurality of surfaces (201, 202, 203, 204, 205) on different planes, and the sensing elements (21, 22, 23, 24, 25) being disposed on the surfaces (201, 202, 203, 204, 205) of the base 20. The electromagnetic radiation source 1 can be visible light or invisible light; alternatively, the electromagnetic radiation source 1 can be point source or collimated source.

Step S102 is: using the sensing elements (21, 22, 23, 24, 25) for receiving different radiation energies generated by the electromagnetic radiations 10 from the electromagnetic radiation source 1 from different spatial angles, the normal vector of the sensing element 21 of the sensing module 2 being parallel to a referring axis Y of a spatial coordinate C, and the normal vectors of the other sensing elements (22, 23, 24, 25) of the sensing module 2 each are relative to the referring axis Y in order to generate corresponding included angles. Therefore, a projection transformation matrix is built by the sensing module 2 relative to the electromagnetic radiation source 1. In other words, the sensing elements (21, 22, 23, 24, 25) respectively receive the different radiation energies from different spatial direction angles generated by the electromagnetic radiation source 1 relative to the sensing elements (21, 22, 23, 24, 25). The radiation energies received by the sensing module 2 are luminous flux. In addition, for example, in the second embodiment, the step S102 further includes using a reflective board 3 for reflecting the electromagnetic radiations 10 from the electromagnetic radiation source 1 onto the sensing module 2.

Step S104 is: selecting the radiation energies that are received by one part of the sensing elements and are larger than the radiation energies received by the other sensing elements.

Step S106 is: the value of the spatial direction angle of the electromagnetic radiation source 1 relative to the sensing module 2 is figured out according to the matrix operation of the radiation energies received by the one part of the sensing elements and the projection transformation matrix built by the sensing module 2 relative to the electromagnetic radiation source 1. In other words, the value of the spatial direction angle of the electromagnetic radiation source 1 relative to the sensing module 2 is figured out according to the magnitude relationship of the radiation energies received by the sensing module 2.

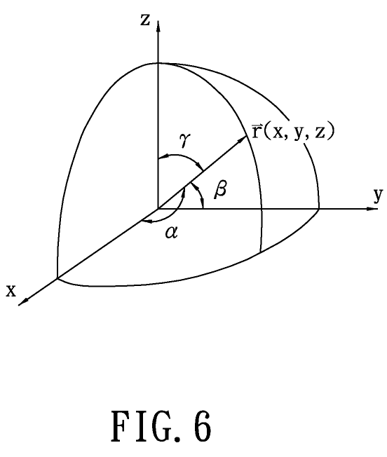

FIG. 6 shows a three-dimensional coordinate schematic diagram of an electromagnetic radiation source relative to the sensing module. The detailed description from the steps S 102 to S 106 is shown as follows:

Firstly, aᵢⱼ=f(P, A, r, \vec{n}) is defined in order to obtain a projection transformation matrix built by the sensing module 2 relative to the electromagnetic radiation source 1.

Moreover, aᵢⱼ=the function of source emitting power;
P source emitting power;
A the area of projection;
r=the distance between the source emitting point and the area of projection; and
\vec{n}=the normal vector of the area of projection.

Secondly, for example, three radiation energies (I₁, I₂, I₃) being received by one part of the sensing elements and being larger than the radiation energies received by the other sensing elements are taken out.

Therefore,

$$[ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{b}_{11} \\ {b}_{21} \\ {b}_{31}\end{matrix} ] = [ \begin{matrix}{I}_{1} \\ {I}_{2} \\ {I}_{3}\end{matrix} ] ⇒ AB = I ⇒ B = {A}^{- 1} I ;$$

Moreover, A=three-dimensional projection transformation matrix;
B=three-dimensional directional angle matrix; and
I=intensity matrix.

Hence, the value of the spatial direction angle of the electromagnetic radiation source 1 relative to the sensing module 2 is figured out according to the matrix operation of the radiation energies received by the one part of the sensing elements and the projection transformation matrix built by the sensing module 2 relative to the electromagnetic radiation source 1.

In other words, because A (the projection transformation matrix built by the sensing module 2 relative to the electromagnetic radiation source 1) and I (maximum intensity matrix) are known, B (the radiation energies received by the one part of the sensing elements) is obtained. Hence, the value of the spatial direction angle bᵢⱼ=g(α, β, γ) of the electromagnetic radiation source 1 relative to the sensing module 2 is figured out, and bᵢⱼ is the function of direction cosine angles of α, β, γ.

In conclusion, the present invention provides a plurality of sensing elements (the sensing module) arranged on different planes for respectively receiving different radiation energies generated by the electromagnetic radiations 10 from different spatial angles, so that the value of a spatial direction angle of the electromagnetic radiation source 1 relative to the sensing module is obtained according to the magnitude relationship of the radiation energies received by the sensing module 2.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A three-dimensional direction detecting device, comprising:
an electromagnetic radiation source for generating electromagnetic radiations; and
a sensing module having a plurality of sensing elements for receiving different radiation energies generated by the electromagnetic radiations from different spatial angles;
whereby, the sensing elements respectively receive the different radiation energies from different spatial direction angles generated by the electromagnetic radiation source relative to the sensing elements, so that the value of a spatial direction angle of the electromagnetic radiation source relative to the sensing module is obtained according to the magnitude relationship of the radiation energies received by the sensing module.

2. The three-dimensional direction detecting device as claimed in claim 1, wherein the electromagnetic radiation source is visible light or invisible light.

3. The three-dimensional direction detecting device as claimed in claim 1, wherein the radiation energies received by the sensing module are luminous flux.

4. The three-dimensional direction detecting device as claimed in claim 1, wherein the number of the sensing elements is at least five.

5. The three-dimensional direction detecting device as claimed in claim 4, wherein the normal vector of one of the sensing elements is parallel to a referring axis of a spatial coordinate, and the normal vectors of the other sensing elements each are relative to the referring axis in order to generate corresponding included angles.

6. The three-dimensional direction detecting device as claimed in claim 1, further comprising a reflective board for reflecting the electromagnetic radiations onto the sensing module.

7. The three-dimensional direction detecting device as claimed in claim 1, wherein the sensing module includes a base that has a plurality of surfaces on different planes, and the sensing elements are disposed on the surfaces of the base.

8. The three-dimensional direction detecting device as claimed in claim 1, wherein the sensing elements are disposed on different planes in space.

9. The three-dimensional direction detecting device as claimed in claim 1, wherein the sensing elements are disposed on the same plane in space.

10. A method for using a three-dimensional direction detecting device, comprising:
(a) providing an electromagnetic radiation source for generating electromagnetic radiations and a sensing module having a plurality of sensing elements;
(b) using the sensing elements for receiving different radiation energies generated by the electromagnetic radiations from the electromagnetic radiation source from different spatial angles; and
(c) obtaining the value of the spatial direction angle of the electromagnetic radiation source relative to the sensing module according to the magnitude relationship of the radiation energies received by the sensing module.

11. The method as claimed in claim 10, wherein the electromagnetic radiation source is visible light or invisible light.

12. The method as claimed in claim 10, wherein the radiation energies received by the sensing module are luminous flux.

13. The method as claimed in claim 10, wherein the number of the sensing elements is at least five.

14. The method as claimed in claim 10, wherein the steps of (b) to (c) further comprises:
building a projection transformation matrix by the sensing module relative to the electromagnetic radiation source, wherein the normal vector of the sensing element is parallel to a referring axis of a spatial coordinate, and the normal vectors of the other sensing elements each are relative to the referring axis in order to generate corresponding included angles;
selecting the radiation energies that are received by one part of the sensing elements and are larger than the radiation energies received by the other sensing elements; and
obtaining the value of the spatial direction angle of the electromagnetic radiation source relative to the sensing module according to the matrix operation of the radiation energies received by the one part of the sensing elements and the projection transformation matrix built by the sensing module relative to the electromagnetic radiation source.

15. The method as claimed in claim 14, wherein the number of the one part of the sensing elements is at least three.

16. The method as claimed in claim 10, wherein the step of (b) further comprises providing a reflective board for reflecting the electromagnetic radiations onto the sensing module.

17. The method as claimed in claim 10, wherein the sensing module includes a base that has a plurality of surfaces on different planes, and the sensing elements are disposed on the surfaces of the base.

18. The method as claimed in claim 10, wherein the sensing elements are disposed on different planes in space.

19. The method as claimed in claim 10, wherein the sensing elements are disposed on the same plane in space.
